(19) United States
(12) Patent Application Publication
(10) Pub. No.: US 2023/0244929 A1
(43) Pub. Date: Aug. 3, 2023

(54) LEARNING DEVICE, GENERATION METHOD, INFERENCE DEVICE, INFERENCE METHOD, AND PROGRAM

(71) Applicant: SONY GROUP CORPORATION, TOKYO (JP)

(72) Inventors: YUHI KONDO, TOKYO (JP); LEGONG SUN, TOKYO (JP); TAISHI ONO, TOKYO (JP); YASUTAKA HIRASAWA, TOKYO (JP)

(21) Appl. No.: 17/998,564

(22) PCT Filed: May 7, 2021
(86) PCT No.: PCT/JP2021/017536

§ 371 Date: Nov. 11, 2022

(30) Foreign Application Priority Data
May 21, 2020 (JP) 2020-088841

(51) Int. Cl. G06N 3/08

(52) U.S. Cl. CPC G06N 3/08

(57) ABSTRACT

The present technology relates to a learning device, a generation method, an inference device, an inference method, and a program that enable learning data suitable for learning to be selected without a manual operation and enable learning of an inference model to be efficiently performed by using the selected learning data.

In a learning device according to one aspect of the present technology, on the basis of a learning data group including learning data having a correct answer and a processing target data group including processing target data for learning, the processing target data for learning having no correct answer and corresponding to data to be processed at the time of inference, the learning device selects, from the learning data group, the learning data suitable for learning of an inference model used at the time of inference, and outputs the selected learning data together with the inference model obtained by performing learning using the selected learning data. The present technology can be applied to a computer that performs learning of CNN.

### TECHNICAL FIELD

The present technology particularly relates to a learning device, a generation method, an inference device, an inference method, and a program that enable learning data suitable for learning to be selected without a manual operation and enable learning of an inference model to be efficiently performed by using the selected learning data.

### BACKGROUND ART

It has been widespread to realize various Tasks using an inference model obtained by machine learning such as Deep Learning.

There are various data sets of learning data used for learning of an inference model, such as a set of handwritten character images used for learning of an inference model for recognizing handwritten characters.

### CITATION LIST

### Non-Patent Document

Non-Patent Document 1: “Object Recognition with Gradient-Based Learning”, (paper on convolutional neural network (CNN)), Yann LeCun et al., http://yann.lecun.com/exdb/publis/pdf/lecun-99.pdf

### SUMMARY OF THE INVENTION

### Problems to be Solved by the Invention

A learning data set includes learning data unsuitable for learning. Therefore, it is usually necessary to manually select a learning data group suitable for learning in advance. The selection of the learning data group is performed for each Task.

In a case where the selection of the learning data group is not performed, a learning time will be long.

The present technology has been made in view of such a situation, enables learning data suitable for learning to be selected without a manual operation, and enables learning of an inference model to be efficiently performed by using the selected learning data.

### Solutions to Problems

A learning device according to one aspect of the present technology includes an information processing unit configured to select, on the basis of a learning data group including learning data having a correct answer and a processing target data group including processing target data for learning, the processing target data for learning having no correct answer and corresponding to data to be processed at the time of inference, from the learning data group, the learning data suitable for learning of an inference model used at the time of inference, and to output the selected learning data together with the inference model obtained by performing learning using the selected learning data.

An inference device according to another aspect of the present technology includes an inference unit configured to input data to be processed into an inference model output from a learning device and output an inference result that represents a result of a predetermined process, in which on the basis of a learning data group including learning data having a correct answer and a processing target data group including processing target data for learning, the processing target data for learning having no correct answer and corresponding to the data to be processed at a time of inference, the learning device selects, from the learning data group, the learning data suitable for learning of an inference model used at the time of inference, and outputs the selected learning data together with the inference model obtained by performing learning using the selected learning data.

In one aspect of the present technology, on the basis of a learning data group including learning data having a correct answer and a processing target data group including processing target data for learning, the processing target data for learning having no correct answer and corresponding to data to be processed at the time of inference, the learning data suitable for learning of an inference model used at the time of inference is selected from the learning data group, and the selected learning data is output together with the inference model obtained by performing learning using the selected learning data.

In another aspect of the present technology, data to be processed is input into an inference model output from a learning device, and an inference result that represents a result of a predetermined process is output, in which on the basis of a learning data group including learning data having a correct answer and a processing target data group including processing target data for learning, the processing target data for learning having no correct answer and corresponding to the data to be processed at the time of inference, the learning device selects, from the learning data group, the learning data suitable for learning of the inference model used at the time of inference, and outputs the selected learning data together with the inference model obtained by performing learning using the selected learning data.

### BRIEF DESCRIPTION OF DRAWINGS

FIG. 1 is a block diagram showing a configuration example of a learning device according to an embodiment of the present technology.

FIG. 2 is a diagram showing an example of execution of a Task using a Task model.

FIG. 3 is a flowchart illustrating a learning process of an optimal data selecting and Task learning unit.

FIG. 4 is a block diagram showing a configuration example of the optimal data selecting and Task learning unit.

FIG. 5 is a block diagram showing another configuration example of the learning device.

FIG. 6 is a flowchart illustrating a learning process of an optimal data generating and Task learning unit.

FIG. 7 is a block diagram showing a configuration example of the optimal data generating and Task learning unit.

FIG. 8 is a flowchart illustrating a learning process of the optimal data generating and Task learning unit.

FIG. 9 is a block diagram showing a configuration example of the optimal data generating and Task learning unit.

FIG. 10 is a block diagram showing a configuration example of an inference device.

FIG. 11 is a block diagram showing a configuration example of a computer.

### MODE FOR CARRYING OUT THE INVENTION

Hereinafter, modes for carrying out the present technology will be described. The description will be given in the following order.

1. First Embodiment: Example of Preparing Learning Data Group Having Correct Answer

2. Second Embodiment: Example of Generating and Preparing Learning Data Group Having Correct Answer

3. Configuration on Inference Side

4. Others

### 1. First Embodiment: Example of Preparing Learning Data Group Having Correct Answer

Configuration of Learning Device

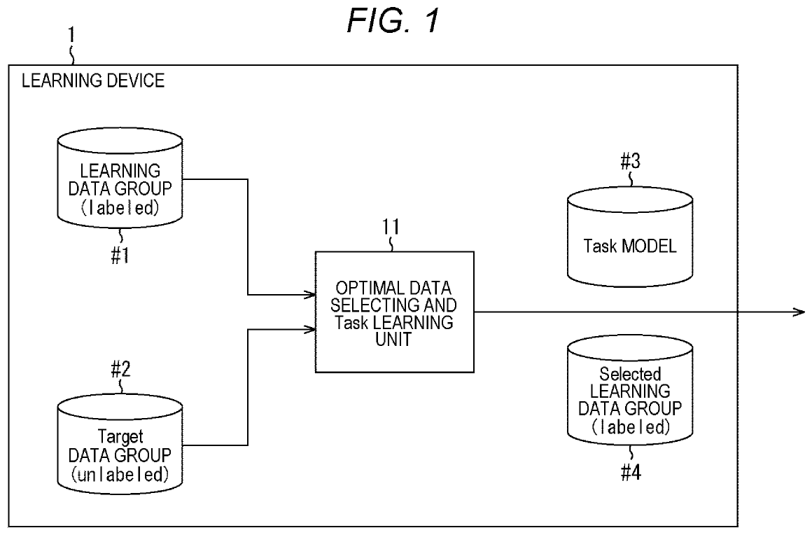

FIG. 1 is a block diagram showing a configuration example of a learning device 1 according to an embodiment of the present technology.

As shown in FIG. 1, the learning device 1 is provided with an optimal data selecting and Task learning unit 11. A learning data group #1 and a Target data group #2 are input from an outside to the optimal data selecting and Task learning unit 11.

The learning data group #1 is a data group including a plurality of pieces of learning data having correct answers (labeled). Each piece of learning data includes Input data of the same type as the Target data and Output data representing a correct answer of a Task.

The Input data is, for example, any data of various types of data such as RGB data (an RGB image), polarization data, multispectral data, and ultraviolet, near-infrared, and far-infrared data which is wavelength data of invisible light.

As the Input data, data actually detected by a sensor in a real space may be used, or data generated by performing rendering on the basis of a three-dimensional model may be used. For example, in a case where the type of the data is the RGB data, the Input data is an image captured by an image sensor or a computer graphics (CG) image generated by a computer by rendering or the like.

The Output data is data corresponding to the Task. For example, in a case where the Task is area division, a result of the area division with the Input data as a target is the Output data. Similarly, in a case where the Task is object normal recognition, a result of the object normal recognition with the Input data as the target is the Output data, and in a case where the Task is depth recognition, a result of the depth recognition with the Input data as the target is the Output data. In a case where the Task is object recognition, a result of the object recognition with the Input data as the target is the Output data.

The Target data group #2 is a data group including a plurality of pieces of Target data of the same type as the Input data of the learning data, which does not have a correct answer (unlabeled). The Target data is data assuming data used as a processing target at the time of inference as Input of an inference model. Data corresponding to the data used as the processing target at the time of inference is input to the learning device 1 as the Target data for learning.

On the basis of the learning data group #1 and the Target data group #2, the optimal data selecting and Task learning unit 11 performs and outputs learning of a Task model #3, which is an inference model used for execution of the Task.

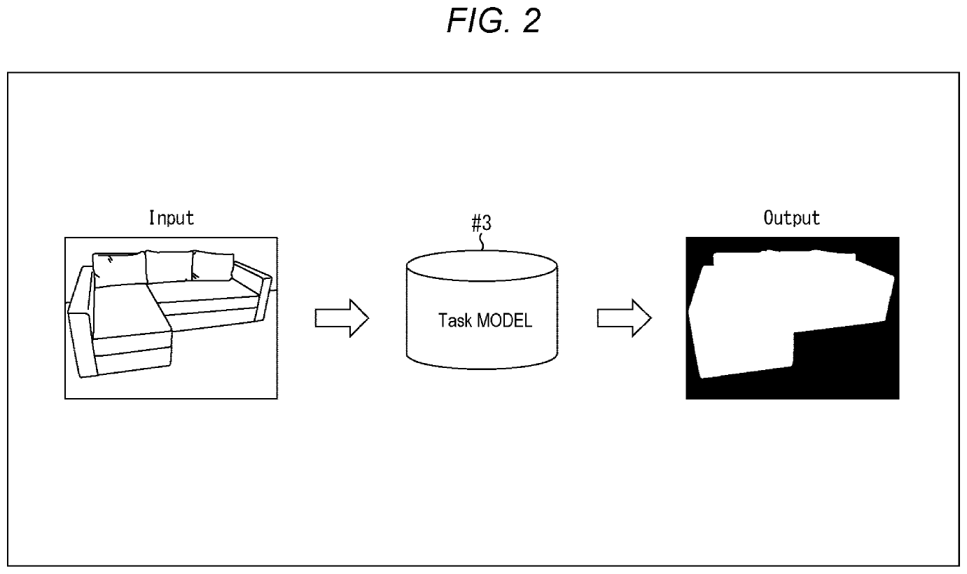

FIG. 2 is a diagram showing an example of execution of the Task using the Task model #3.

In a case where the Task is area division, as shown in FIG. 2, an inference model in which the RGB data is set as Input and a result of the area division is set as Output is generated as the Task model #3. In the example of FIG. 2, in response to input of an image showing a sofa as an object, an image representing an area where the sofa is shown is output.

In a case where the Task model #3 is a convolutional neural network (CNN), information representing a configuration and a weight of a neural network is output from the optimal data selecting and Task learning unit 11.

Note that learning of a network of a type different from the CNN may be performed in the optimal data selecting and Task learning unit 11, or machine learning different from Deep Learning may be performed in the optimal data selecting and Task learning unit 11.

In addition, the optimal data selecting and Task learning unit 11 selects learning data suitable for learning of the Task model #3 from the learning data group #1. The learning of the Task model #3 is performed on the basis of the selected learning data.

The optimal data selecting and Task learning unit 11 outputs a plurality of pieces of learning data selected from the learning data group #1 as a Selected learning data group #4, together with the Task model #3. Learning data constituting the Selected learning data group #4 is data having a correct answer.

Accordingly, the optimal data selecting and Task learning unit 11 functions as an information processing unit that selects the learning data suitable for learning of the Task model #3 on the basis of the learning data group #1 and the Target data group #2 including the Target data for learning, and outputs the Selected learning data group #4 together with the Task model #3 obtained by performing learning using the selected learning data.

Since the learning data suitable for learning of the inference model according to the Task is automatically selected, it is unnecessary to manually select the learning data. The learning data group #1 is, for example, a data group prepared in advance as a learning data set. The learning data constituting the learning data group #1 is data not manually selected.

In addition, since the learning data selected as data suitable for learning of the inference model is used for learning, efficient learning can be performed by using a small amount of learning data.

Since the learning data is selected by using the Target data group #2 assuming the Target data to be processed at the time of inference, characteristics of the Target data used at the time of inference can be detected in advance by analyzing the Selected learning data group #4. For example, in a case where the Task is depth recognition, a range of a distance to be a result of the depth recognition, and the like can be detected in advance. The analysis of the Selected learning data group #4 is performed, for example, in a subsequent device that receives the Selected learning data group #4 output from the learning device 1.

Operation of Optimal Data Selecting and Task Learning Unit 11

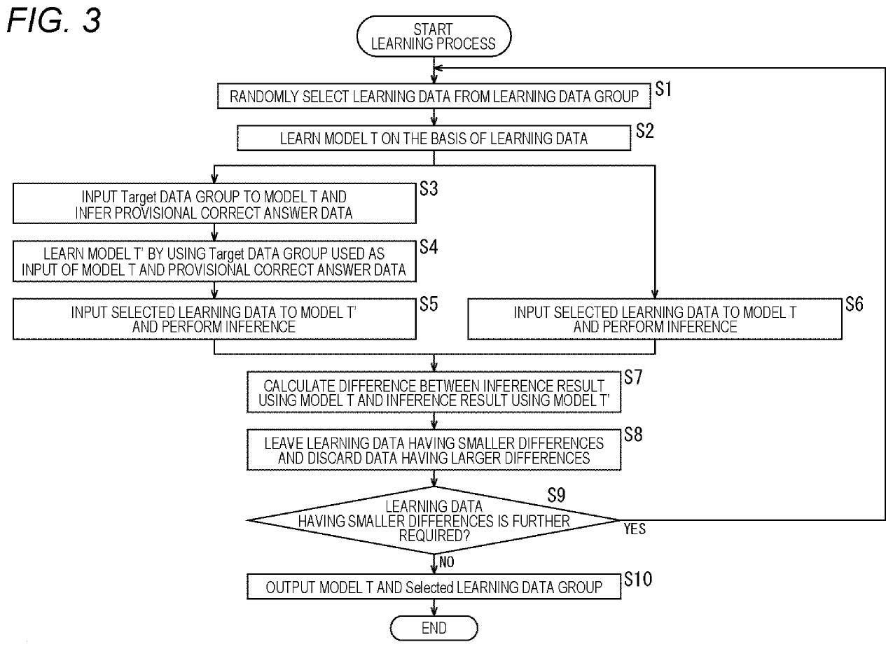

A learning process of the optimal data selecting and Task learning unit 11 will be described with reference to a flowchart of FIG. 3.

In step S1, the optimal data selecting and Task learning unit 11 randomly selects a predetermined number of pieces of learning data from the learning data group #1.

In step S2, the optimal data selecting and Task learning unit 11 performs learning of a model T on the basis of the learning data selected in step S1. Here, the learning of the inference model is performed in which the Input data of the learning data is set as an input and the Output data prepared as the correct answer is set as an output.

In step S3, the optimal data selecting and Task learning unit 11 inputs the Target data group #2 to the model T and infers provisional correct answer data. That is, an inference result output in response to the input of the Target data to the model T is set as the provisional correct answer data.

In step S4, the optimal data selecting and Task learning unit 11 performs learning of a model T′ by using the Target data group #2 used in step S3 as the input of the model T and the provisional correct answer data. Here, the learning of the inference model is performed in which the Target data constituting the Target data group #2 is set as an input and the provisional correct answer data obtained when the Target data is input to the model T is set as an output.

In step S5, the optimal data selecting and Task learning unit 11 inputs the learning data selected in step S1 into the model T′ and performs inference.

In step S6, the optimal data selecting and Task learning unit 11 inputs the learning data selected in step S1 to the model T and performs inference.

In step S7, the optimal data selecting and Task learning unit 11 calculates a difference between an inference result obtained by using the model T in step S6 and an inference result obtained by using the model T′ in step S5. Assuming that an inference result when learning data x is input to the model T is set as T(x) and an inference result when the learning data x is input to the model T′ is set as T′(x), a difference s between the two is expressed by the following Formula (1).

[Mathematical Formula 1]

s=∥T(x)−T′(x)∥ (1)

In step S8, the optimal data selecting and Task learning unit 11 leaves learning data having smaller differences and discards data having larger differences. For example, 50% of the learning data is left in ascending order of the differences, and the other 50% of the learning data is deleted. The learning data left here is held as learning data constituting the Selected learning data group #4.

In step S9, the optimal data selecting and Task learning unit 11 determines whether or not the learning data having the smaller differences is further required. In a case where it is determined in step S9 that the learning data having the smaller differences is further required, the process returns to step S1, and a subsequent process is performed. The processes of steps S1 to S9 are repeated as a loop process.

In the process of step S1 which is repeatedly performed, new learning data that has not been used for learning so far is randomly selected from the learning data group #1, and the new learning data is added to the left learning data. That is, another piece of learning data is selected instead of the learning data that has not been selected as the learning data constituting the Selected learning data group #4, and is added to the learning data used in the current loop process. The processes in and after step S2 are performed on the basis of the learning data to which the new learning data is added.

In a case where it is determined in step S9 that the learning data having the smaller difference is not required, in step S10, the optimal data selecting and Task learning unit 11 outputs the model T at that time as the Task model #3. In addition, the optimal data selecting and Task learning unit 11 outputs the learning data selected so far as the Selected learning data group #4, together with the Task model #3.

Configuration of Optimal Data Selecting and Task Learning Unit 11

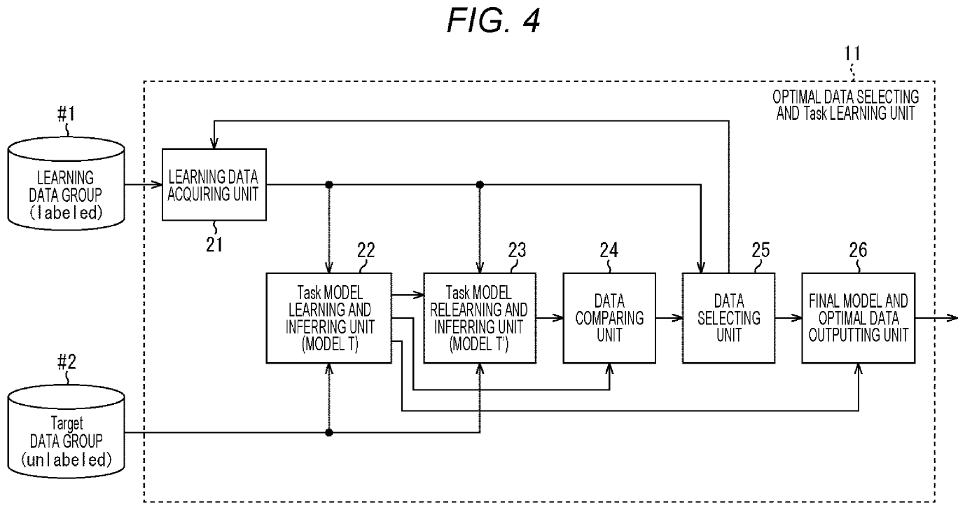

FIG. 4 is a block diagram showing a configuration example of the optimal data selecting and Task learning unit 11 performing the processes in FIG. 3.

As shown in FIG. 4, the optimal data selecting and Task learning unit 11 includes a learning data acquiring unit 21, a Task model learning and inferring unit 22, a Task model relearning and inferring unit 23, a data comparing unit 24, a data selecting unit 25, and a final model and optimal data outputting unit 26. The learning data group #1 input from the outside is supplied to the learning data acquiring unit 21, and the Target data group #2 is supplied to the Task model learning and inferring unit 22 and the Task model relearning and inferring unit 23.

The learning data acquiring unit 21 randomly selects and acquires the learning data from the learning data group #1. In a first loop process in the learning process described with reference to FIG. 3, all pieces of the learning data are randomly selected, and in second and subsequent loop processes, the learning data to be added to the learning data selected by the data selecting unit 25 is randomly selected. The process of step S1 in FIG. 3 is a process performed by the learning data acquiring unit 21.

The learning data selected by the learning data acquiring unit 21 is supplied to the Task model learning and inferring unit 22, the Task model relearning and inferring unit 23, and the data selecting unit 25.

The Task model learning and inferring unit 22 performs learning of the model T on the basis of the learning data supplied from the learning data acquiring unit 21. The Task model learning and inferring unit 22 functions as a first learning unit that performs the learning of the model T as a first model. In addition, the Task model learning and inferring unit 22 inputs the Target data group #2 to the model T and infers the provisional correct answer data.

Furthermore, the Task model learning and inferring unit 22 inputs the learning data selected by the learning data acquiring unit 21 to the model T and performs inference. The processes of steps S2, S3, and S6 in FIG. 3 are processes performed by the Task model learning and inferring unit 22.

The model T obtained by learning performed by the Task model learning and inferring unit 22 is supplied to the final model and optimal data outputting unit 26, and the provisional correct answer data obtained by inference using the model T is supplied to the Task model relearning and inferring unit 23. An inference result (T(x)) obtained by the inference using the model T is supplied to the data comparing unit 24.

The Task model relearning and inferring unit 23 performs learning of the model T′ by using the Target data group #2 and the provisional correct answer data supplied from the Task model learning and inferring unit 22. The Task model relearning and inferring unit 23 functions as a second learning unit that performs the learning of the model T′ as a second model. In addition, the Task model relearning and inferring unit 23 inputs the learning data to the model T′ and performs inference. The processes of steps S4 and S5 in FIG. 3 are processes performed by the Task model relearning and inferring unit 23.

An inference result (T′(x)) obtained by the inference using the model T′ is supplied to the data comparing unit 24.

The data comparing unit 24 calculates a difference s between the inference result obtained by using the model T supplied from the Task model learning and inferring unit 22 and the inference result obtained by using the model T′ supplied from the Task model relearning and inferring unit 23. The process of step S7 in FIG. 3 is a process performed by the data comparing unit 24.

As the difference s, an absolute value of the difference described with reference to the above Formula (1) may be obtained, or a square error may be obtained. Information representing the difference s is supplied to the data selecting unit 25.

The data selecting unit 25 selects the learning data on the basis of the difference s supplied from the data comparing unit 24. For example, the learning data is selected by a threshold process of leaving the learning data whose difference s is equal to or less than a threshold, or by leaving the learning data at a predetermined ratio in ascending order of the differences. The processes of steps S8 and S9 in FIG. 3 are processes performed by the data selecting unit 25.

In a case where an end condition of the learning is satisfied, the learning data selected and held by the data selecting unit 25 is supplied to the final model and optimal data outputting unit 26. For example, a condition that the difference s of all pieces of the learning data used for the processes in the Task model learning and inferring unit 22, the Task model relearning and inferring unit 23, and the like becomes equal to or less than the threshold, a condition that the loop process in FIG. 3 is repeated a predetermined number of times, and the like are set as the end condition of the learning.

In a case where the end condition of the learning is satisfied, the final model and optimal data outputting unit 26 outputs the model T supplied from the Task model learning and inferring unit 22 as the Task model #3 and outputs the learning data supplied from the data selecting unit 25 as the Selected learning data group #4.

Accordingly, by using the Target data group #2 having no correct answer for learning, the learning data suitable for learning can be selected and output. In addition, the inference model obtained by the learning using the learning data suitable for learning can be generated and output.

### 2. Second Embodiment: Example of Generating and Preparing Learning Data Group Having Correct Answer

<2-1. Example of Generating Learning Data Group by Randomly Setting Parameter>

Configuration of Learning Device

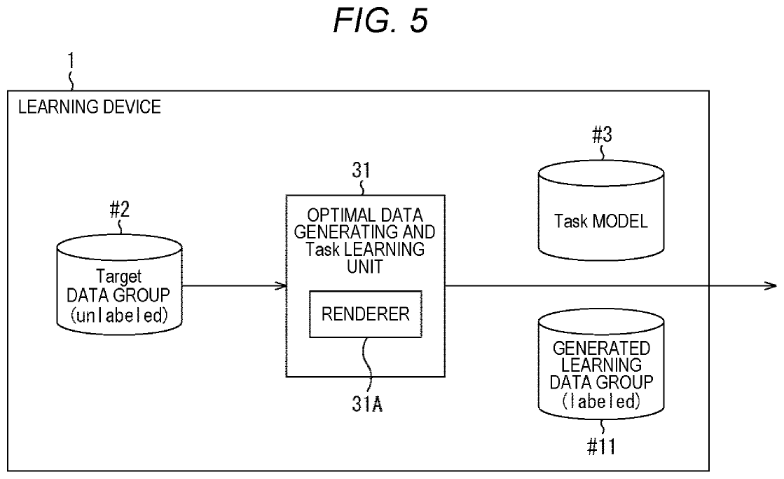

FIG. 5 is a block diagram showing another configuration example of the learning device 1.

In the learning device 1 shown in FIG. 5, the learning data used for learning of the Task model #3 is not prepared in advance, but is generated by the learning device 1 itself. The learning or the like of the Task model #3 is performed as described above by using the learning data generated by the learning device 1.

As shown in FIG. 5, the learning device 1 is provided with an optimal data generating and Task learning unit 31 instead of the optimal data selecting and Task learning unit 11 in FIG. 1. The optimal data generating and Task learning unit 31 includes a renderer 31A. The Target data group #2 is input from the outside to the optimal data generating and Task learning unit 31. A description overlapping with the above description will be appropriately omitted.

The optimal data generating and Task learning unit 31 uses the renderer 31A to generate the learning data as described above including the Input data of the same type as the Target data and the Output data representing the correct answer to the Task.

In a case where the Input data is, for example, an RGB image, the optimal data generating and Task learning unit 31 performs rendering on the basis of a three-dimensional model, and generates a CG image (an RGB image of CG) including a predetermined object. In the optimal data generating and Task learning unit 31, data of three-dimensional models of various objects is prepared.

For example, in a case of generating the CG image including the sofa as described with reference to FIG. 2, the optimal data generating and Task learning unit 31 sets various learning data generating parameters, and performs rendering on the basis of a three-dimensional model of the sofa to generate the CG image. The learning data generating parameter is a parameter that defines a content of rendering. The rendering is performed on the basis of a plurality of types of the learning data generating parameters in which predetermined values are set.

In a case where the Input data is data of a type other than RGB data, such as polarization data, multispectral data, or wavelength data of invisible light, the rendering is similarly performed on the basis of the three-dimensional model, and the CG image as the Input data is generated.

The optimal data generating and Task learning unit 31 performs simulation on the basis of the learning data generating parameters used for rendering the Input data and the like to generate the Output data representing the correct answer and to generate the learning data including the Input data and the Output data. The optimal data generating and Task learning unit 31 generates a learning data group including a plurality of pieces of learning data by changing setting of the learning data generating parameters or changing the three-dimensional model used for the rendering.

The process performed in the learning device 1 of FIG. 5 is similar to the process performed in the learning device 1 of FIG. 1 except that the learning data is generated. The optimal data generating and Task learning unit 31 in FIG. 5 outputs the Task model #3 and a generated learning data group #11 including learning data selected as being suitable for the learning of the Task model #3 from the generated learning data.

Accordingly, the learning data can be generated in the learning device 1 instead of being prepared in advance.

Operation of Optimal Data Generating and Task Learning Unit 31

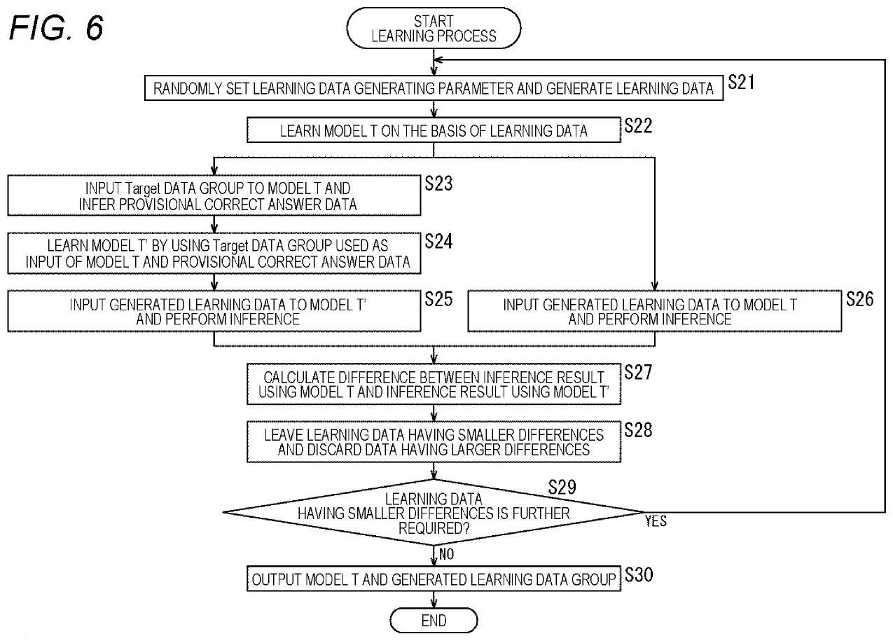

A learning process of the optimal data generating and Task learning unit 31 will be described with reference to a flowchart of FIG. 6.

In step S21, the optimal data generating and Task learning unit 31 randomly sets the learning data generating parameters and generates the learning data. Here, a plurality of pieces of the learning data is generated by changing the setting of the learning data generating parameters.

Processes in and after step S22 are basically similar to the processes in and after step S2 in FIG. 3.

That is, in step S22, the optimal data generating and Task learning unit 31 performs learning of the model T on the basis of the learning data generated in step S21.

In step S23, the optimal data generating and Task learning unit 31 inputs the Target data group #2 to the model T and infers the provisional correct answer data.

In step S24, the optimal data generating and Task learning unit 31 performs learning of the model T′ by using the Target data group #2 used in step S23 as the input of the model T and the provisional correct answer data.

In step S25, the optimal data generating and Task learning unit 31 inputs the learning data generated in step S21 to the model T′ and performs inference.

In step S26, the optimal data generating and Task learning unit 31 inputs the learning data generated in step S21 to the model T and performs inference.

In step S27, the optimal data generating and Task learning unit 31 calculates a difference between an inference result obtained by using the model T in step S26 and an inference result obtained by using the model T′ in step S25.

In step S28, the optimal data generating and Task learning unit 31 leaves the learning data having the smaller differences and discards the data having the larger differences.

In step S29, the optimal data generating and Task learning unit 31 determines whether or not the learning data having the smaller differences is further required. In a case where it is determined in step S29 that the learning data having the smaller differences is further required, the process returns to step S21, and a subsequent process is performed. The processes of steps S21 to S29 are repeated as a loop process.

In the process of step S21 that is repeatedly performed, the learning data generating parameter is randomly set, new learning data is generated, and the new learning data is added to the left learning data. That is, another piece of learning data is generated instead of the learning data that has not been selected as the learning data constituting the generated learning data group #11, and is added to the learning data used in the current loop process. The processes in and after step S22 are performed on the basis of the learning data to which the newly generated learning data is added.

In a case where it is determined in step S29 that the learning data having the smaller differences is not required, in step S30, the optimal data generating and Task learning unit 31 outputs the model T at that time as the Task model #3. In addition, the optimal data generating and Task learning unit 31 outputs the learning data generated and selected so far as the generated learning data group #11, together with the Task model #3.

Configuration of Optimal Data Generating and Task Learning Unit 31

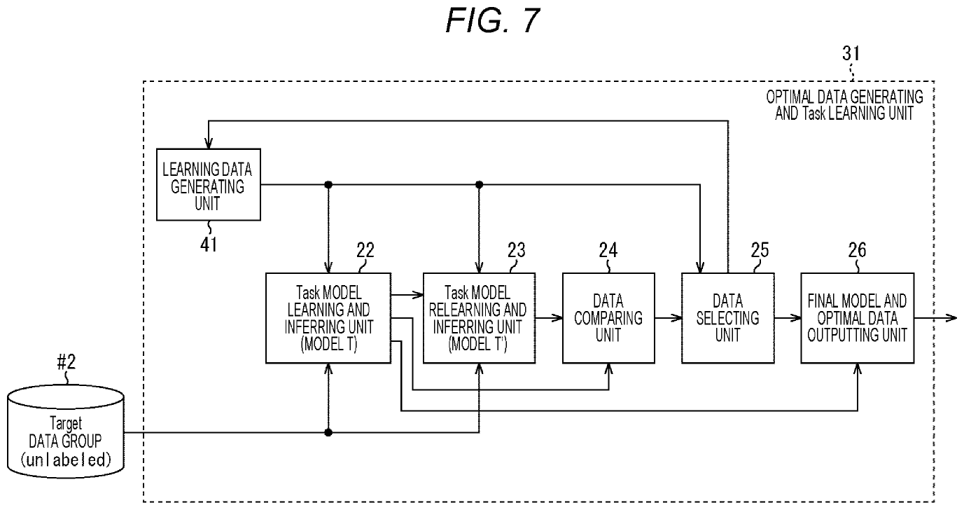

FIG. 7 is a block diagram showing a configuration example of the optimal data generating and Task learning unit 31 performing the process in FIG. 6.

In the configuration shown in FIG. 7, the same configurations as those described with reference to FIG. 4 are denoted by the same reference numerals. An overlapping description will be omitted as appropriate. The configuration of the optimal data generating and Task learning unit 31 shown in FIG. 7 is the same as the configuration of the optimal data selecting and Task learning unit 11 in FIG. 4 except that a learning data generating unit 41 is provided instead of the learning data acquiring unit 21.

The learning data generating unit 41 generates the Input data constituting the learning data by randomly setting the learning data generating parameter and performing the rendering based on the three-dimensional model. The learning data generating unit 41 is implemented by the renderer 31A.

For example, the learning data generating parameter includes the following parameters.

Parameter Related to Object
Orientation of object
Position of object
Material of object
Shape of object
High level information (information that specifies type of object (chair, desk, sofa, and the like))
Low level information (information that directly specifies vertex of mesh)

Parameter Related to Light Source
Type of light source (point, spot, area, environment map, and the like)
Orientation of light source
Position of light source
Characteristics of light source (wavelength (ultraviolet to visible light to near infrared and far infrared), polarization (stokes vector))

Parameter Related to Camera
External parameter (orientation, position, and the like of camera)
Internal parameter (FoV, focal length, and the like)
Characteristics of image sensor (noise model and the like)

In addition, the learning data generating unit 41 performs simulation and generates, for each Input data, the Output data being the correct answer according to the Task. The learning data generating unit 41 generates a plurality of pieces of the learning data by changing the setting of the learning data generating parameter or changing the three-dimensional model used for rendering.

In a first loop process in the learning process described with reference to FIG. 6, all pieces of the learning data are generated, and in second and subsequent loop processes, the learning data to be added to the learning data selected by the data selecting unit 25 is randomly generated. The process of step S21 in FIG. 6 is a process performed by the learning data generating unit 41.

The learning data generated by the learning data generating unit 41 is supplied to the Task model learning and inferring unit 22, the Task model relearning and inferring unit 23, and the data selecting unit 25.

Accordingly, even in the case of generating the learning data, by using the Target data group #2 having no correct answer for learning, the learning data suitable for learning can be selected and output. In addition, the inference model obtained by the learning using the learning data suitable for learning can be generated and output.

<2-2. Example of Generating Learning Data Group by Specifying Parameter Condition>

The learning data generating parameter that defines the content of the rendering is randomly set, and the learning data generating parameter may be set according to a condition.

In the loop process which is repeatedly performed, new learning data is generated instead of the learning data determined to be unsuitable for the learning of the model T. What kind of the learning data is only required to be generated as the new learning data can be specified on the basis of tendency or the like of the learning data determined to be suitable for the learning of the model T. A condition as to what kind of the learning data (Input data) is only required to be generated is specified on the basis of a result of a previous loop process.

Operation of Optimal Data Generating and Task Learning Unit 31

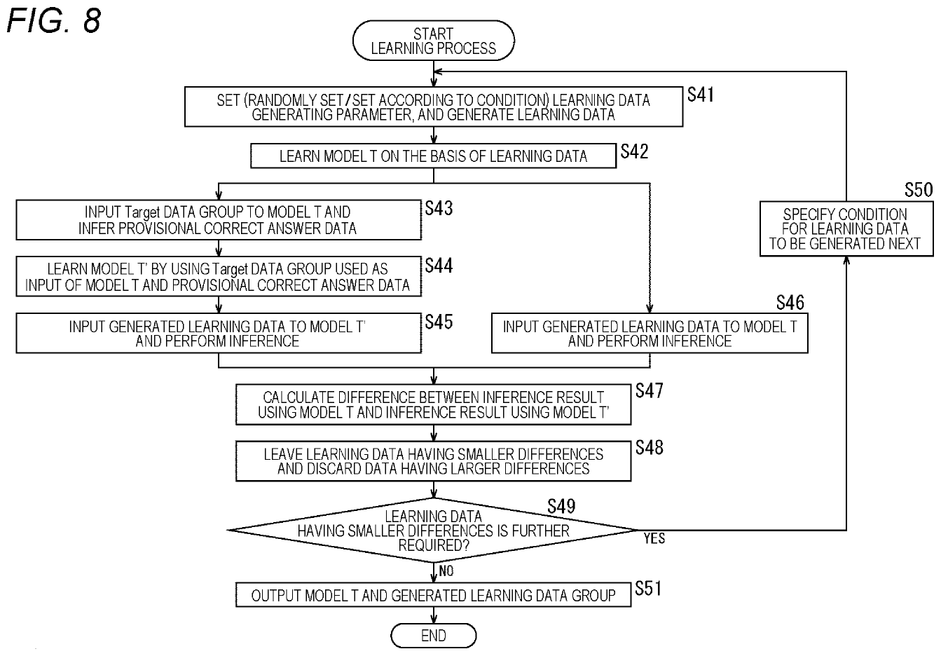

A learning process of the optimal data generating and Task learning unit 31 will be described with reference to a flowchart of FIG. 8.

The process shown in FIG. 8 is similar to the process described with reference to FIG. 6 except that a condition as to what kind of the learning data is only required to be generated is specified on the basis of a result of an immediately preceding loop process.

That is, in step S41, the optimal data generating and Task learning unit 31 randomly sets the learning data generating parameter and generates the learning data. Processes of steps S42 to S48 are performed by using the learning data generated on the basis of the learning data generating parameter set randomly.

In step S49, the optimal data generating and Task learning unit 31 determines whether or not the learning data having the smaller differences is further required.

In a case where it is determined in step S49 that the learning data having the smaller differences is further required, in step S50, the optimal data generating and Task learning unit 31 specifies a condition for learning data to be generated next. Thereafter, the process returns to step S41, and the subsequent process is performed.

In the process of step S41 that is repeatedly performed, the learning data generating parameter is set according to the condition, and new learning data is generated. In addition, the newly generated learning data is added to the left learning data, and the processes in and after step S42 are performed.

In a case where it is determined in step S49 that the learning data having the smaller differences is not required, in step S51, the optimal data generating and Task learning unit 31 outputs the model T at that time as the Task model #3. In addition, the optimal data generating and Task learning unit 31 outputs the learning data generated and selected so far as the generated learning data group #11.

Configuration of Optimal Data Generating and Task Learning Unit 31

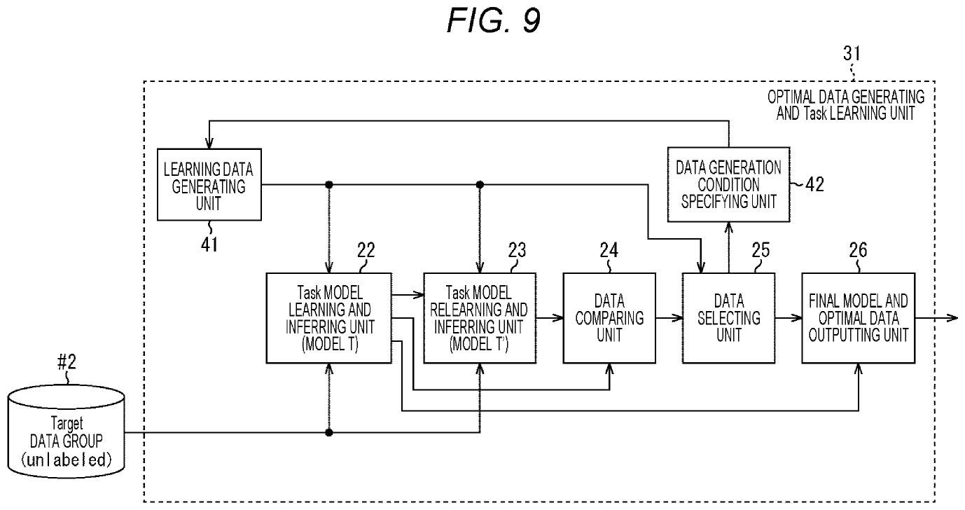

FIG. 9 is a block diagram showing a configuration example of the optimal data generating and Task learning unit 31 performing the process in FIG. 8.

The configuration of the optimal data generating and Task learning unit 31 shown in FIG. 9 is the same as the configuration of the optimal data generating and Task learning unit 31 in FIG. 7 except that a data generation condition specifying unit 42 is additionally provided.

The data generation condition specifying unit 42 specifies a condition for learning data to be newly generated on the basis of information supplied from the data selecting unit 25. For example, information regarding the difference s between the held learning data and the learning data discarded without being held is supplied from the data selecting unit 25.

Specifically, with respect to a parameter for specifying a position of a camera and a position of light (light source), it is specified as a condition that the learning data is newly generated by using a parameter of a direction with a smaller error. The parameter of the direction with the smaller error is searched by using a search algorithm such as a hill-climbing method.

For example, it is assumed that there are an azimuth, a zenith, and a distance from a subject as external parameters related to the camera, and learning data with azimuths set to 40 deg, 45 deg, and 50 deg have already existed (have been generated). In this case, when the difference s obtained by using the learning data is, in ascending order, learning data with the azimuth of 40 deg, learning data with the azimuth of 45 deg, and learning data with the azimuth of 50 deg, learning data with an azimuth of 35 deg is specified to be generated next.

In a case where there are an azimuth, a zenith, and a distance from a subject as parameters related to the light, a condition is specified similarly.

A condition may be specified that learning data similar to the learning data having the smaller difference s is newly generated. Whether or not the learning data is similar is determined by using, for example, an index such as a peak signal-to-noise ratio (PSNR), a structural similarity (SSIM), or a mean squared error (MSE). Whether or not the newly generated learning data is actually used for learning in the Task model learning and inferring unit 22 and the like may be determined by comparing with the learning data group generated in a previous loop process.

The data generation condition specifying unit 42 outputs, to the learning data generating unit 41, information that specifies such a condition. The process of step S50 in FIG. 8 is a process performed by the data generation condition specifying unit 42.

The data generation condition specifying unit 42 automatically determines what kind of the learning data is only required to be generated.

Accordingly, by specifying a condition of learning data to be generated in a next loop process on the basis of a processing result of the previous loop process, the learning data can be efficiently generated, and a time required for learning can be shortened.

Learning of what kind of the learning data is only required to be generated may be performed by a genetic algorithm or the like. The learning is performed on the basis of the difference s calculated by using the learning data and the learning data generating parameter used to generate the learning data.

As described above, according to the learning device 1, the learning data suitable for learning can be selected without a manual operation. In addition, the learning of the inference model can be efficiently performed by using the selected learning data.

### 3. Configuration on Inference Side

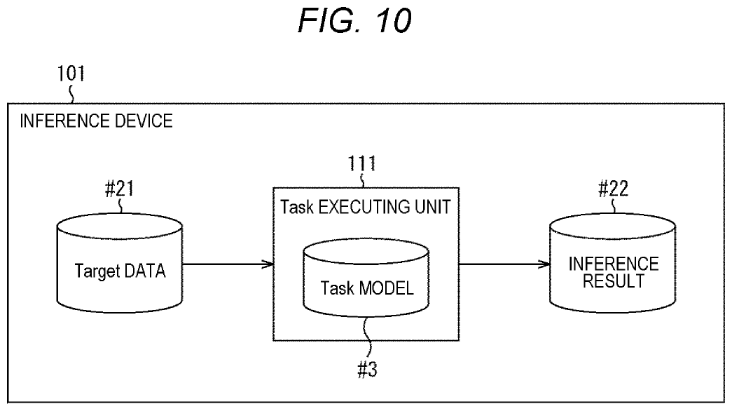

FIG. 10 is a block diagram showing a configuration example of an inference device 101.

As shown in FIG. 10, the inference device 101 is provided with a Task executing unit 111 including the Task model #3 output from the learning device 1. Target data #21 is input to the Task executing unit 111. The Target data #21 is the same type of data as the Target data constituting the Target data group #2.

The Task executing unit 111 inputs the Target data #21 input as a processing target to the Task model #3 and outputs an inference result #22. For example, in a case where the Task model #3 prepared in the Task executing unit 111 is an inference model for a Task of area division, and an RGB image is input as the Target data #21, a result of the area division is output as the inference result #22.

### 4. Others

The learning of the model T and the model T′ performed in the learning device 1 is performed so as to learn a model using any of regression, a decision tree, a neural network, Bayes, clustering, and time series prediction.

The learning of the model T and the model T′ may be performed by ensemble learning.

Configuration Example of Computer

The above-described series of processes can be executed by hardware or software. In a case where the series of processes is executed by software, a program constituting the software is installed from a program recording medium to a computer incorporated in dedicated hardware, a general-purpose personal computer, or the like.

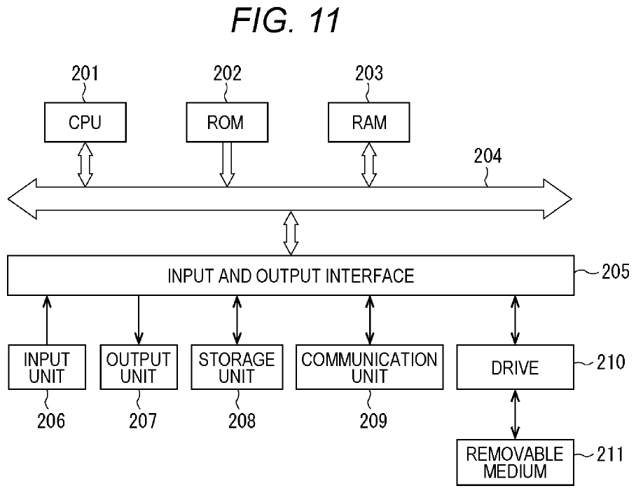

FIG. 11 is a block diagram showing a configuration example of hardware of a computer that executes the above-described series of processes by a program.

The learning device 1 and the inference device 101 are implemented by the computer as shown in FIG. 11. The learning device 1 and the inference device 101 may be implemented in the same computer or may be implemented in different computers.

A central processing unit (CPU) 201, a read only memory (ROM) 202, and a random access memory (RAM) 203 are mutually connected by a bus 204.

An input and output interface 205 is further connected to the bus 204. An input unit 206 including a keyboard, a mouse, and the like, and an output unit 207 including a display, a speaker, and the like are connected to the input and output interface 205. In addition, the input and output interface 205 is connected with a storage unit 208 including a hard disk, a nonvolatile memory, and the like, a communication unit 209 including a network interface and the like, and a drive 210 that drives a removable medium 211.

In the computer configured as described above, for example, the CPU 201 loads a program stored in the storage unit 208 into the RAM 203 via the input and output interface 205 and the bus 204 and executes the program, so that the above-described series of processes is performed.

The program executed by the CPU 201 is provided, for example, by being recorded in the removable medium 211 or via a wired or wireless transmission medium such as a local area network, the Internet, or digital broadcasting, and is installed in the storage unit 208.

The program executed by the computer may be a program in which processes are performed in time series in the order described in the present description, or may be a program in which processes are performed in parallel or at necessary timing such as when a call is made.

Note that, in the present description, a system means a set of a plurality of components (devices, modules (parts), and the like), and it does not matter whether or not all the components are in the same housing. Therefore, a plurality of devices housed in separate housings and connected via a network, and one device in which a plurality of modules is housed in one housing are all systems.

The effect described in the present description is merely an example and is not limited, and other effects may be exerted.

The embodiments of the present technology are not limited to the above-described embodiments, and various modifications can be made without departing from the gist of the present technology.

For example, the present technology can adopt a configuration of cloud computing in which one function is shared and processed in cooperation by a plurality of devices via a network.

In addition, the steps described in the above-described flowcharts can be executed by one device or can be shared and executed by a plurality of devices.

Furthermore, in a case where a plurality of processes is included in one step, the plurality of processes included in the one step can be executed by one device or can be shared and executed by a plurality of devices.

Example of Combination of Configurations

The present technology can also have the following configuration.

(1)

A learning device including:

an information processing unit configured to select, on the basis of a learning data group including learning data having a correct answer and a processing target data group including processing target data for learning, the processing target data for learning having no correct answer and corresponding to data to be processed at the time of inference, from the learning data group, the learning data suitable for learning of an inference model used at the time of inference, and to output the selected learning data together with the inference model obtained by performing learning using the selected learning data.

(2)

The learning device according to (1), in which

the information processing unit performs a process including selection of the learning data on the basis of the learning data group and the processing target data group input from an outside.

(3)

The learning device according to (1) or (2), further including:

a data acquiring unit configured to randomly acquire the learning data from the learning data group; and

a first learning unit configured to perform learning of a first model by using the randomly acquired learning data.

(4)

The learning device according to (3), further including:

a second learning unit configured to perform learning of a second model in which an inference result obtained by inputting the processing target data to the first model is set as a provisional correct answer, the processing target data is set as an input, and the provisional correct answer is set as an output.

(5)

The learning device according to (4), further including:

a data comparing unit configured to compare a first inference result obtained by inputting the randomly acquired learning data to the first model with a second inference result obtained by inputting the same learning data to the second model; and

a data selecting unit configured to select the learning data suitable for the learning of the inference model on the basis of a comparison result.

(6)

The learning device according to (5), in which

the data selecting unit selects, as the learning data suitable for the learning of the inference model, the learning data used as an input for inference of the second inference result having a difference from the first inference result smaller than a threshold.

(7)

The learning device according to (5) or (6), further including:

an output unit configured to output the first model obtained by repeatedly performing learning as the inference model together with the learning data selected by the data selecting unit, in which

the data acquiring unit randomly selects another piece of the learning data instead of the learning data not selected by the data selecting unit,

the first learning unit repeatedly performs the learning of the first model by using the learning data selected by the data selecting unit and the another piece of the learning data randomly acquired, and

the second learning unit repeatedly performs the learning of the second model by using an inference result of the first model obtained by the learning performed by the first learning unit.

(8)

The learning device according to any of (1) to (7), in which

the learning data is at least any one of RGB data, polarization data, multispectral data, or wavelength data of invisible light.

(9)

The learning device according to any of (1) to (8), in which

the learning data is data detected by a sensor or data generated by a computer.

(10)

The learning device according to (4), in which

the learning of the first model and the second model is performed so as to learn a model using any of regression, a decision tree, a neural network, Bayes, clustering, and time series prediction.

(11)

The learning device according to (1), further including: a learning data generating unit configured to generate the learning data group on the basis of a three-dimensional model of an object, in which

the information processing unit performs a process including selection of the learning data on the basis of the generated learning data group and the input processing target data group.

(12)

The learning device according to (11), in which

the learning data generating unit generates the learning data group including the learning data including data of a rendering result of the object and having a simulation result of a state of the object as a correct answer.

(13)

The learning device according to (11) or (12), further including:

a first learning unit configured to perform learning of a first model by using the generated learning data; and

a second learning unit configured to perform learning of a second model in which an inference result obtained by inputting the processing target data to the first model is set as a provisional correct answer, the processing target data is set as an input, and the provisional correct answer is set as an output.

(14)

The learning device according to (13), further including:

a data comparing unit configured to compare a first inference result obtained by inputting the generated learning data to the first model with a second inference result obtained by inputting the same learning data to the second model; and

a data selecting unit configured to select the learning data suitable for learning of the inference model on the basis of a comparison result.

(15)

The learning device according to (14), further including:

a condition specifying unit configured to specify a condition of the learning data to be newly generated on the basis of the learning data used as an input for inference of the second inference result having a difference from the first inference result smaller than a threshold.

(16)

A generation method including:

by a learning device,

on the basis of a learning data group including learning data having a correct answer and a processing target data group including processing target data for learning, the processing target data for learning having no correct answer and corresponding to data to be processed at the time of inference, selecting, from the learning data group, the learning data suitable for learning of an inference model used at the time of inference;

outputting the selected learning data; and

generating the inference model by performing learning using the selected learning data.

(17)

A program for executing, by a computer, a process of:

on the basis of a learning data group including learning data having a correct answer and a processing target data group including processing target data for learning, the processing target data for learning having no correct answer and corresponding to data to be processed at the time of inference, selecting, from the learning data group, the learning data suitable for learning of an inference model used at the time of inference;

outputting the selected learning data; and

generating the inference model by performing learning using the selected learning data.

(18)

An inference device, including:

an inference unit configured to input data to be processed into an inference model output from a learning device and output an inference result that represents a result of a predetermined process, in which on the basis of a learning data group including learning data having a correct answer and a processing target data group including processing target data for learning, the processing target data for learning having no correct answer and corresponding to the data to be processed at a time of inference, the learning device selects, from the learning data group, the learning data suitable for learning of the inference model used at the time of inference, and outputs the selected learning data together with the inference model obtained by performing learning using the selected learning data.

(19)

An inference method including:

by an inference device,

inputting data to be processed into an inference model output from a learning device, in which on the basis of a learning data group including learning data having a correct answer and a processing target data group including processing target data for learning, the processing target data for learning having no correct answer and corresponding to the data to be processed at a time of inference, the learning device selects, from the learning data group, the learning data suitable for learning of the inference model used at the time of inference, and outputs the selected learning data together with the inference model obtained by performing learning using the selected learning data; and

outputting an inference result that represents a result of a predetermined process.

(20)

A program for executing, by a computer, a process of:

inputting data to be processed into an inference model output from a learning device, in which on the basis of a learning data group including learning data having a correct answer and a processing target data group including processing target data for learning, the processing target data for learning having no correct answer and corresponding to the data to be processed at a time of inference, the learning device selects, from the learning data group, the learning data suitable for learning of the inference model used at the time of inference, and outputs the selected learning data together with the inference model obtained by performing learning using the selected learning data; and

outputting an inference result that represents a result of a predetermined process.

### REFERENCE SIGNS LIST

1 Learning device
11 Optimal data selecting and Task learning unit
21 Learning data acquiring unit
22 Task model learning and inferring unit
23 Task model relearning and inferring unit
24 Data comparing unit
25 Data selecting unit
26 Final model and optimal data outputting unit
31 Optimal data generating and Task learning unit
41 Learning data generating unit
42 Data generation condition specifying unit
101 Inference device
111 Task executing unit

1. A learning device comprising:
an information processing unit configured to select, on a basis of a learning data group including learning data having a correct answer and a processing target data group including processing target data for learning, the processing target data for learning having no correct answer and corresponding to data to be processed at the time of inference, from the learning data group, the learning data suitable for learning of an inference model used at the time of inference, and to output the selected learning data together with the inference model obtained by performing learning using the selected learning data.

2. The learning device according to claim 1, wherein
the information processing unit performs a process including selection of the learning data on a basis of the learning data group and the processing target data group input from an outside.

3. The learning device according to claim 1, further comprising:
a data acquiring unit configured to randomly acquire the learning data from the learning data group; and
a first learning unit configured to perform learning of a first model by using the randomly acquired learning data.

4. The learning device according to claim 3, further comprising:
a second learning unit configured to perform learning of a second model in which an inference result obtained by inputting the processing target data to the first model is set as a provisional correct answer, the processing target data is set as an input, and the provisional correct answer is set as an output.

5. The learning device according to claim 4, further comprising:
a data comparing unit configured to compare a first inference result obtained by inputting the randomly acquired learning data to the first model with a second inference result obtained by inputting the same learning data to the second model; and
a data selecting unit configured to select the learning data suitable for learning of the inference model on a basis of a comparison result.

6. The learning device according to claim 5, wherein
the data selecting unit selects, as the learning data suitable for learning of the inference model, the learning data used as an input for inference of the second inference result having a difference from the first inference result smaller than a threshold.

7. The learning device according to claim 5, further comprising:
an output unit configured to output the first model obtained by repeatedly performing learning as the inference model together with the learning data selected by the data selecting unit, wherein
the data acquiring unit randomly selects another piece of the learning data instead of the learning data not selected by the data selecting unit,
the first learning unit repeatedly performs learning of the first model by using the learning data selected by the data selecting unit and the another piece of the learning data randomly acquired, and
the second learning unit repeatedly performs learning of the second model by using an inference result of the first model obtained by learning performed by the first learning unit.

8. The learning device according to claim 1, wherein
the learning data is at least any one of RGB data, polarization data, multispectral data, or wavelength data of invisible light.

9. The learning device according to claim 1, wherein
the learning data is data detected by a sensor or data generated by a computer.

10. The learning device according to claim 4, wherein
the learning of the first model and the second model is performed so as to learn a model using any of regression, a decision tree, a neural network, Bayes, clustering, and time series prediction.

11. The learning device according to claim 1, further comprising:
a learning data generating unit configured to generate the learning data group on a basis of a three-dimensional model of an object, wherein
the information processing unit performs a process including selection of the learning data on a basis of the generated learning data group and the input processing target data group.

12. The learning device according to claim 11, wherein
the learning data generating unit generates the learning data group including the learning data including data of a rendering result of the object and having a simulation result of a state of the object as a correct answer.

13. The learning device according to claim 11, further comprising:
a first learning unit configured to perform learning of a first model by using the generated learning data; and
a second learning unit configured to perform learning of a second model in which an inference result obtained by inputting the processing target data to the first model is set as a provisional correct answer, the processing target data is set as an input, and the provisional correct answer is set as an output.

14. The learning device according to claim 13, further comprising:
a data comparing unit configured to compare a first inference result obtained by inputting the generated learning data to the first model with a second inference result obtained by inputting the same learning data to the second model; and
a data selecting unit configured to select the learning data suitable for learning of the inference model on a basis of a comparison result.

15. The learning device according to claim 14, further comprising:
a condition specifying unit configured to specify a condition of the learning data to be newly generated on a basis of the learning data used as an input for inference of the second inference result having a difference from the first inference result smaller than a threshold.

16. A generation method comprising:
by a learning device,
on a basis of a learning data group including learning data having a correct answer and a processing target data group including processing target data for learning, the processing target data for learning having no correct answer and corresponding to data to be processed at the time of inference, selecting, from the learning data group, the learning data suitable for learning of an inference model used at the time of inference;
outputting the selected learning data; and
generating the inference model by performing learning using the selected learning data.

17. A program for executing, by a computer, a process of:
on a basis of a learning data group including learning data having a correct answer and a processing target data group including processing target data for learning, the processing target data for learning having no correct answer and corresponding to data to be processed at the time of inference, selecting, from the learning data group, the learning data suitable for learning of an inference model used at the time of inference;
outputting the selected learning data; and
generating the inference model by performing learning using the selected learning data.

18. An inference device, comprising:
an inference unit configured to input data to be processed into an inference model output from a learning device and output an inference result that represents a result of a predetermined process, wherein on a basis of a learning data group including learning data having a correct answer and a processing target data group including processing target data for learning, the processing target data for learning having no correct answer and corresponding to the data to be processed at a time of inference, the learning device selects, from the learning data group, the learning data suitable for learning of the inference model used at the time of inference, and outputs the selected learning data together with the inference model obtained by performing learning using the selected learning data.

19. An inference method comprising:
by an inference device,
inputting data to be processed into an inference model output from a learning device, wherein on a basis of a learning data group including learning data having a correct answer and a processing target data group including processing target data for learning, the processing target data for learning having no correct answer and corresponding to the data to be processed at a time of inference, the learning device selects, from the learning data group, the learning data suitable for learning of the inference model used at the time of inference, and outputs the selected learning data together with the inference model obtained by performing learning using the selected learning data; and
outputting an inference result that represents a result of a predetermined process.

20. A program for executing, by a computer, a process of:
inputting data to be processed into an inference model output from a learning device, wherein on a basis of a learning data group including learning data having a correct answer and a processing target data group including processing target data for learning, the processing target data for learning having no correct answer and corresponding to the data to be processed at a time of inference, the learning device selects, from the learning data group, the learning data suitable for learning of the inference model used at the time of inference, and outputs the selected learning data together with the inference model obtained by performing learning using the selected learning data; and
outputting an inference result that represents a result of a predetermined process.
